(19) United States
(12) Patent Application Publication
(10) Pub. No.: US 2019/0080257 A1
(43) Pub. Date: Mar. 14, 2019

(54) CHECKPOINTING DISK CONFIGURATION USING MACHINE LEARNING

(71) Applicant: Intel Corporation, Santa Clara, CA (US)

(72) Inventors: LI CHEN, Hillsboro, OR (US); ERDEM AKTAS, Beaverton, OR (US)

(73) Assignee: Intel Corporation, Santa Clara, CA (US)

(21) Appl. No.: 15/699,860

(22) Filed: Sep. 8, 2017

(51) Int. Cl. G06N 99/00; G06N 5/04; G06N 7/00

(52) U.S. Cl. CPC G06N 99/005; G06N 7/005; G06N 5/04

(57) ABSTRACT

One embodiment provides a system including processor, a storage device, training logic and runtime prediction logic to develop a model to enable improved checkpointing. The training logic trains the model using simulated or known data to predict a size of a changelog needed for checkpointing. The size of the changelog is correlated to user type and timespan (as a checkpoint tracking changes made over a full week is likely larger than a checkpoint tracking changes made over a single day, and some types of users make more changes than others). Thus, the training logic utilizes sample data corresponding to various user types and timespans to train and validate the model for various combinations. Once the model is trained, the training logic may send the trained model to the runtime prediction model for use during operation of the system. During operation, the runtime prediction logic uses the model to predict a size of a reserved area where the changelog will be stored. The runtime prediction logic also monitors actual use of the reserved area during operation over time (e.g., tracks the size of the changelog as it grows) and compares the changelog size to the predictions from the model. The runtime prediction logic revises the model as needed based on the actual use. Thus, the system improves checkpointing by reducing wasted space.

### FIELD

The present disclosure relates to checkpointing of storage devices using machine learning.

### BACKGROUND

Many modern storage devices such as a solid-state drives (SSDs) support checkpointing, enabling the drive to revert back to an earlier state. While initially appearing similar to a traditional backup, checkpointing usually consumes far less space; rather than storing an entire independent copy of the system (or portion thereof) being protected, a typical checkpoint system merely tracks changes (e.g., to files/memory addresses) over time. This can protect a user's information/system in case of a malware attack, e.g., ransomware, without consuming; as ransomware typically manifests by gradually encrypting contents of a drive over time, a compromised checkpoint system may be able to revert the changes being made.

However, checkpointing is not a panacea—there are a number of current challenges. For example, as the list of tracked changes (“changelog”) is typically stored on the drive being protected, actual hardware failures (e.g., of the drive itself) can result in irrecoverable data loss. Additionally, checkpointing usually relies on the changelog including an unbroken chain of changes in order to enable reversion to the oldest stored change. In other words, when reverting to an earlier state, the system “walks back” through each stored change, so if a change is lost, skipped or otherwise missing, the system is unlikely to be able to revert to a state of the system before the missing change. This necessarily makes checkpointing systems time-limited; as more and more changes are made over time via typical use of the system, the changelog will accordingly continue to grow in size unless older changes are deleted, rendering the system unable to revert to before any deleted older changes. Thus, any storage space provisioned for storing the changelog usually needs to be of sufficient size to store every change that may occur over the desired time period.

Running out of space typically results in the system deleting the oldest changes (eliminating opportunity to revert to before them) or failing to record new changes (possibly rendering the entire changelog moot). Additionally, the amount of storage space needed to store the changelog may vary widely based on a number of factors. Typical systems account for this by heavily overestimating the amount of space required in order to leave room for error. However, as one of the goals of checkpointing is to provide protection while conserving space, an ideal system would provision enough space to ensure room for the changelog while simultaneously minimizing unused/wasted space as much as possible. Thus, a method or system capable of more accurate space requirement estimations would be particularly advantageous.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a storage system consistent with several embodiments of the present disclosure;

FIG. 2 illustrates a storage device consistent with several embodiments of the present disclosure;

FIG. 3 illustrates inputs and outputs of training logic consistent with several embodiments of the present disclosure;

FIG. 4 illustrates inputs and outputs of runtime prediction logic consistent with several embodiments of the present disclosure;

FIG. 5 is a flowchart illustrating operations consistent with various embodiments of the present disclosure;

FIG. 6 is a flowchart illustrating operations consistent with various embodiments of the present disclosure;

FIG. 7 illustrates several possible user types of a user according to several embodiments of the present disclosure; and

FIG. 8 illustrates an example user interface to enable a user to set up checkpointing and input parameters.

Although the following Detailed Description will proceed with reference being made to illustrative embodiments, many alternatives, modifications, and variations thereof will be apparent to those skilled in the art.

### DETAILED DESCRIPTION

The systems and methods disclosed herein provide improved determination of a size of a reserved area on a storage device. As a non-limiting example, a system consistent with the present disclosure may include a processor, a storage device, training logic and runtime prediction logic to develop a model to enable improved checkpointing. The system may train the model using simulated or known data to predict a size of a changelog needed for checkpointing. The size of the changelog may be correlated to user type and timespan (a checkpoint tracking changes made over a full week will likely be larger than a checkpoint tracking changes made over a single day, and some types of users make more changes than others). Thus, the training logic may utilize sample data corresponding to various user types and timespans to train and validate the model for various combinations. Once the model is trained, the training logic may send the trained model to the runtime prediction model for use during operation.

During operation, if checkpointing is initiated, the system may prompt a user to select a user type (e.g., internet surfer, gamer, enterprise user, programmer, etc.) and a desired checkpoint timespan. Once the inputs are received, the system may then use the appropriate model with the inputs to determine a predicted size of the reserved area. The runtime prediction logic may further monitor actual use of the reserved area during operation over time (e.g., track the size of the changelog as it grows) and compare the changelog size to the predictions from the model. If the reserved area is likely to be insufficient (i.e., if the changelog is growing much faster than predicted), the runtime prediction logic may revise the model and attempt to expand the reserved area. If the reserved area is too large (implying a possible waste of storage space), the runtime prediction logic may revise the model and reduce the reserved area. Thus, the system may improve checkpointing by reducing wasted space.

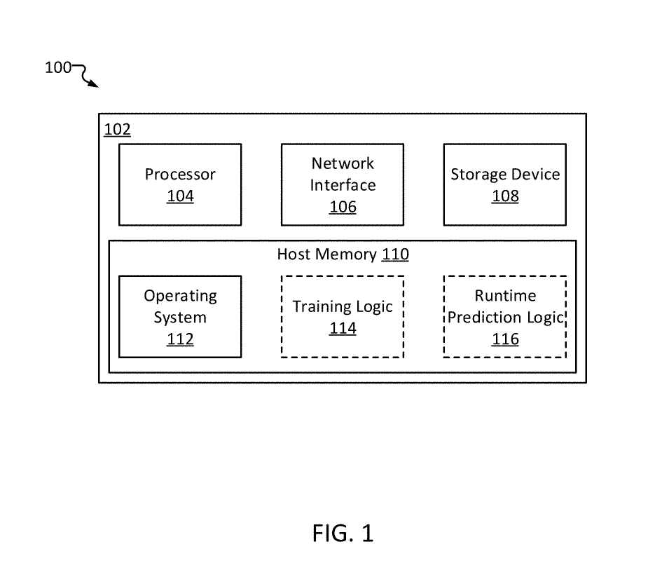

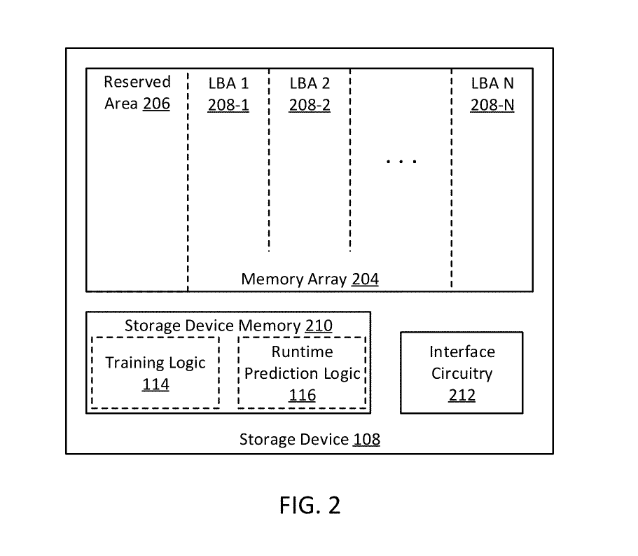

FIG. 1 illustrates a storage system 100 consistent with several embodiments of the present disclosure. System 100 may include a processor 104, network interface circuitry 106, a storage device 108, and host memory 110. Host memory 110 may include an operating system (OS) 112. In addition, host memory 110 may include training logic 114 and runtime prediction logic 116, while in some embodiments, training logic 114 and runtime prediction logic 116 may be stored on storage device 108, as will be described in further detail regarding FIG. 2 below.

System 100 is generally configured to maintain a changelog of operations made to storage device 108 to enable a checkpointing backup system. As will be described below, a portion of memory on storage device 108 may be reserved for storing the changelog. System 100 is further generally configured to determine a size of the reserved area sufficient to store the changelog over a set duration. Training logic 114 is generally configured to train a model using sample data to determine a size of the reserved area based on one or more features (e.g., file operation statistics such as reads/writes, file names, file locations, etc.). Runtime prediction logic 116 is generally configured to implement the model while system 100 is in operation. Runtime prediction logic 116 may be further configured to compare the actual storage consumption of the changelog to the output of the model in order to ensure that storage device 108 has enough space to store the changelog and update the model as may be necessary.

Storage system 100 is generally configured to implement checkpointing to enable reversion (or rollback) of stored data to an earlier state. Reversion may be prompted by, for example, a user (e.g., in response to determining a security compromise—ransomware infection, other malware attacks, etc.). In some embodiments, reversion may be prompted automatically based on, e.g., malware detection. In some embodiments, in response to automated malware detection, system 100 may prompt a user to inform the user of a security compromise and enable the user to trigger checkpoint reversion.

Host memory 110 may include volatile random-access memory (RAM), e.g., dynamic RAM (DRAM), static RAM (SRAM), etc. OS 112 running on host memory 110 may be any of a plurality of operating systems such as Microsoft Windows 10, OS X, one or more Linux distributions, etc. Processor 104 may correspond to a single core or a multi-core general purpose processor, such as those provided by Intel® Corp., etc. Processor 104 may comprise an architecture such as ARM, x86, etc. Network interface circuitry 106 may include any of a plurality of circuits or buses to enable system 100 to communicate with other systems. Connections may be wired (e.g., Cat5e Ethernet, USB, etc.) or wireless (e.g., Bluetooth, WiFi, etc.).

Storage device 108 may include a hard disk drive (HDD), non-volatile memory (NVM) circuitry, e.g., a storage medium that does not require power to maintain the state of data stored by the storage medium. Nonvolatile memory may include, but is not limited to, a solid state drive (SSD) using, e.g., NAND flash memory (e.g., a Triple Level Cell (TLC) NAND or any other type of NAND (e.g., Single Level Cell (SLC), Multi-Level Cell (MLC), Quad Level Cell (QLC), etc.)), NOR memory, solid state memory (e.g., planar or three Dimensional (3D) NAND flash memory or NOR flash memory), storage devices that use chalcogenide phase change material (e.g., chalcogenide glass), byte addressable nonvolatile memory devices, ferroelectric memory, silicon-oxide-nitride-oxide-silicon (SONOS) memory, polymer memory (e.g., ferroelectric polymer memory), byte addressable random accessible 3D crosspoint memory, ferroelectric transistor random access memory (Fe-TRAM), magnetoresistive random access memory (MRAM), phase change memory (PCM, PRAM), resistive memory, ferroelectric memory (F-RAM or FeRAM), spin-transfer torque memory (STT), thermal assisted switching memory (TAS), millipede memory, floating junction gate memory (FJG RAM), magnetic tunnel junction (MTJ) memory, electrochemical cells (ECM) memory, binary oxide filament cell memory, interfacial switching memory, battery-backed RAM, ovonic memory, nanowire memory, electrically erasable programmable read-only memory (EEPROM), etc. In some embodiments, the byte addressable random accessible 3D crosspoint memory may include a transistor-less stackable cross point architecture in which memory cells sit at the intersection of words lines and bit lines and are individually addressable and in which bit storage is based on a change in bulk resistance.

FIG. 2 illustrates a storage device 108 consistent with several embodiments of the present disclosure. Storage device 108 may include a memory array 204 including a plurality of logical block arrays (LBAs) 208-1 through 208-N. Memory array 204 may further include a reserved area 206. The size (e.g., in kilobytes) of the reserved area may be determined by runtime prediction logic 116, as will be described in further detail below. Storage device 108 further includes storage device memory 210 and interface circuitry 212. In some embodiments, storage device memory 210 may include one or both of training logic 114 and runtime prediction logic 116. Storage device memory 210 may include volatile RAM as described in relation to host memory 110, above. Interface circuitry 212 may include drivers, circuitry and/or buses to enable storage device 108 to connect and interface with a computing system (e.g., complying with specifications or standards such as Serial AT Attachment (SATA), USB, Peripheral Component Interconnect Express (PCIe), Next Generation Form Factor (NGFF) aka M.2, etc.).

As a general matter, as an application (not shown) is executed by processor 104, read and/or write operations targeting the memory array 204 may be issued by a file system associated with the OS 112. Such read and write operations generally include an LBA having an associated LBA sector size to be read from storage device 108 and/or written to storage device 108. In some embodiments, the LBA sector size may be a single, fixed size, e.g. 512 Bytes, and in other embodiments (as will be described below), the LBA sector size may be different for different applications/usage models.

Reserved area 206 may be configured such that some applications executing on the OS 112 may be prevented from accessing (reading from, writing to) data stored in the reserved area. For example, system 100 may prevent all applications outside runtime prediction logic 116 from writing data to reserved area 206, and may additionally prevent untrusted applications from reading data from reserved area 206.

As applications are executed by processor 104, read/write operations are stored in a changelog in reserved area 206 for a set duration (e.g., 2 days, 7 days, etc.). This duration may be a preset value, selected by a user, a default value that may be later modified by a user, etc. As the oldest entries in the changelog age past the set duration, storage device 108 may overwrite or otherwise mark the old entries for deletion to make room for newer entries. In some embodiments, if reserved area 206 is full or nearly full (e.g., if the size of the changelog is approaching or has reached the size of reserved area 206), as new changes are made, storage device 108 automatically overwrites or deletes the oldest changes of the changelog in order to make room for newer entries. While this may result in loss of the earliest state the system can revert back to, it may advantageously maintain checkpointing ability, as checkpointing typically requires a continuous chain of tracked changes.

The changes stored in the changelog may generally be restricted to write operations. The checkpointing system may store every write operation for maximum accuracy and reliability. However, storing every write operation may result in the changelog requiring significant amounts of reserved storage space, which may be unacceptable depending upon user preferences. Thus, in some embodiments the checkpointing system may omit certain write operations. For example, system 100 may determine that a write operation corresponds to a temporary file, which may not be necessary for checkpointing purposes. Additionally, some write operations that are frequently repeated (e.g., performed 10 times within 1 minute) or write operations corresponding to a file or application responsible for frequent write operations (e.g., a file that has performed over 10 write operations in the last minute) may also be omitted in order to conserve space in the changelog. Frequent operations may be identified via file path and filename, e.g., system 100 may track how often a particular filename at a particular location is associated with a write operation, and if the frequency is above a particular threshold, write operations associated with that file may be omitted. The changelog may include a granularity, e.g., a length of time of an “epoch,” wherein write operations are stored in the changelog according to which epoch they occurred in. In some embodiments, rather than every set amount of time, the changelog may be updated, e.g., at every system shutdown, when prompted by a security application, on demand by a user, etc.

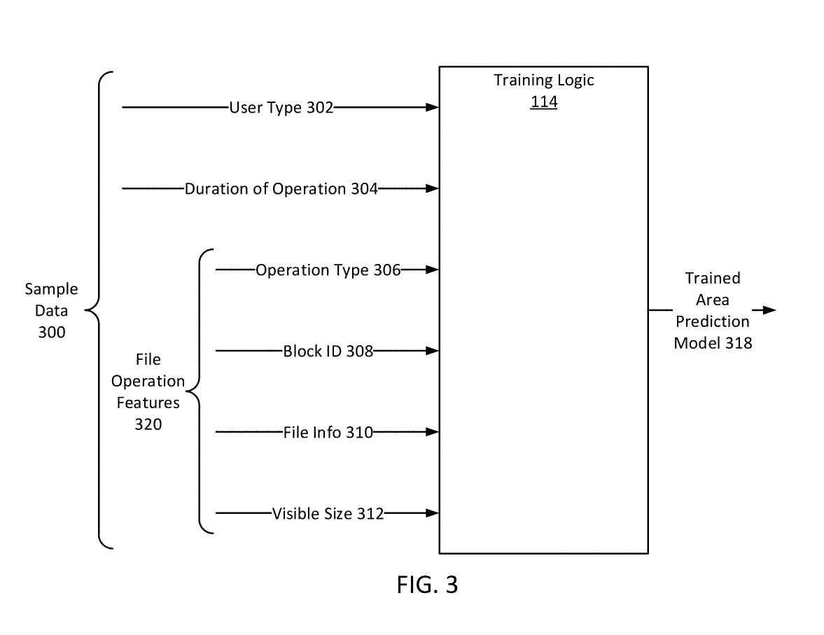

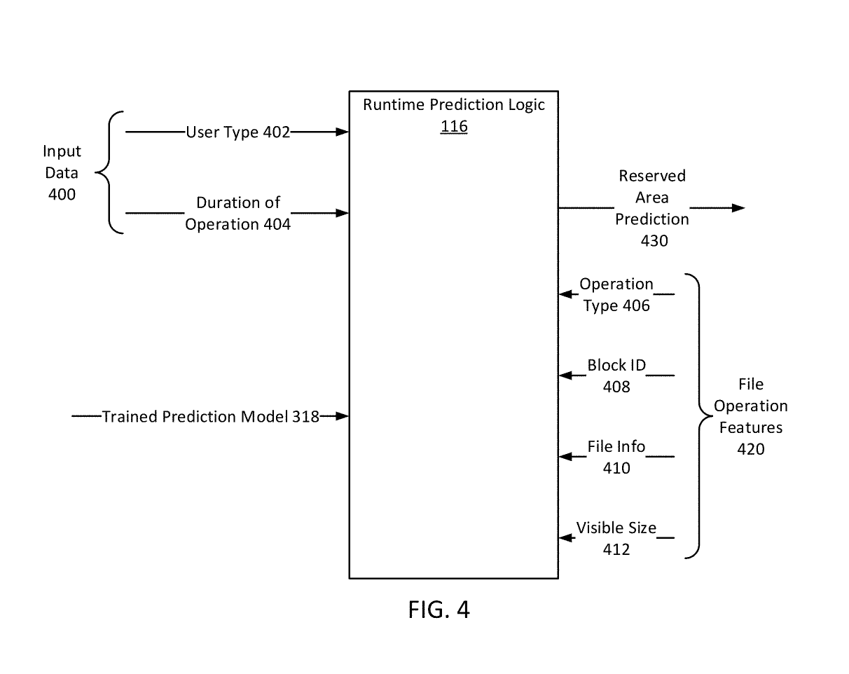

Training logic 114 may be stored on storage device memory 210 or on host memory 110. In general, training logic 114 is configured to train a prediction model to determine a size needed for reserved area 206 to store a checkpointing changelog. Training logic 114 is discussed in further detail regarding FIG. 3, below. Runtime prediction logic 116 may similarly be stored on storage device memory 210 or on host memory 110. In general, runtime prediction logic 116 is configured to use the trained model to determine a size of reserved area 206 and to use machine learning to modify the model during operation of system 100 (e.g., as applications are executed by processor 104). Runtime prediction logic 116 is discussed in further detail regarding FIG. 4, below.

FIG. 3 illustrates inputs and outputs of training logic 114 consistent with several embodiments of the present disclosure. Training logic 114 is generally configured to train an area prediction model 318 (hereinafter referred to as “model 318”) to determine a size of reserved area 206 to store a changelog of changes made to system 100. Training logic 114 may train model 318 for multiple use cases (e.g., varying user types). Training logic 114 may receive sample data corresponding to typical usage of a system for various use cases. For example, the sample data for one use case may include a user type 302, a duration of operation 304, and a time series of file operation features 320. The file operation features 320 identify read/write requests made to a storage device, including operation type 306, a block ID 308, file name and file location information 310 for each request, along with a total visible size 312 (e.g., in MB) of the storage device. Training logic 114 may further determine additional features based on the sample data. The additional features may include a daily usage ratio, defined as an amount of data (e.g., in kB) added or modified over a time period divided by the total available space in the storage device at the beginning of the time period. Additional features also may include a desired space, representing a difference between the amount of data added or modified and a temporary allocated data amount, wherein the temporary allocated data amount is determined based on the received file information. The temporary allocated data amount may enable model 318 to account for write operations associated with temporary files which, in some embodiments, may be omitted from the changelog (e.g., do not contribute to size of area 206). In some embodiments, temporary files may be identified based on path and filename (e.g., in Windows, file extensions beginning with˜may indicate that a file is a temporary file), while in the same or other embodiments, operating systems may include a “temporary” tag or indicator in the file itself.

The sample features may be received in a time series format with a granularity. As an example, the received read/write requests (and other features) may be sorted into groups based on periods of time, wherein features that “occurred” during the same period of time are grouped together. The periods of time are typically all the same length, and equal to the granularity of the feature set. The data may have a granularity of, for example, 30 minutes, 1 hour, 5 hours, 12 hours, etc. Thus, an exemplary sample feature set having a granularity of 1 hour would indicate, for every hour of the duration of operation 304, what file operations 320 occurred during that hour. In some embodiments, the sample data set is a recorded data set of actual use, while in other embodiments the sample data set is simulated (e.g., generated based on multiple recorded sets, randomly generated, etc.).

Training logic 114 may use file operation features 320 (and any determined additional features) to determine a size of a sample changelog. For example, if file operation features 320 indicate that 50 10 kB reads and 20 5 MB writes occurred over the duration of operation 304, the sample changelog may be 100 MB (5*20 MB=100 MB, and reads may not be checkpointed), though in other embodiments the changelog may be smaller if some operations (e.g., those associated with temporary files) are omitted. While some file operation features may not directly impact size of the changelog (e.g., file name/location information 310, visible size 312), they may be correlated with usage trends, and therefore enable increased accuracy of model 318.

In some embodiments, training logic 114 may assume a size of a sample changelog based on the sample data for an initial training condition. For example, training logic 114 may assume that the size of the sample changelog is a flat value (e.g., 1 GB) or a portion of the visible size 312 of a storage device, e.g. half, one third, two thirds, etc. This initial assumption may be further based on user type 302 or duration of operation 302. For example, training logic 114 may start with a flat assumption of 1 GB/day, with multipliers based on user type 302; e.g., if user type 302 is “gamer,” the assumption may be multiplied by 2.5. Thus, for at least this example, if user type 302 is “gamer” and duration of operation 304 is 7 days, an initial assumption may be 1 GB/day*2.5*7 days=17.5 GB. In some embodiments, the received sample data set may include an initial assumption. In the same or other embodiments, the assumed size may be of the reserved area (e.g., reserved area 206) rather than the sample changelog size. These values may differ, as will be explained in further detail below.

Training logic 114 may split, divide, or otherwise categorize the received sample data. For example, a first portion (e.g., half) of the sample data may be used for training model 318, while another portion may be reserved for validation. In some embodiments, some portions may be used for training initially but later for validation (e.g., cross-validation). For some model types (e.g., polynomial models), this may prevent “overfitting” the model. Sample data 300 may be divided based on granularity (e.g., in a sample set with 10-hour duration with 1 hour granularity, sample data may be divided by first 5 hours and second 5 hours), number of operations, time (e.g., regardless of granularity), etc.

In some embodiments, model 318 may be a linear regression model with the format yₜ=β₀ₜ+β₁ₜF₁ₜ+β₂ₜF₂ₜ+ . . . +β_{dt}F_{dt}+ϵ, wherein yₜ is a size of the changelog at t, β is a vector of model parameters, F is an array of features, d is the total number of features, ϵ is an error, and t is an epoch index of the sample data set corresponding to time, wherein the granularity of the data set is the duration of operation 304 divided by the total number of epochs (max(t)).

In at least one embodiment, training logic 114 may assume that the size of the changelog increases linearly with time t, and thus, with an initially assumed size Y (determined as described above), model 318 may assume that: yₜ=nₜ*Y, wherein n₁, n₂ . . . n_{T} is a uniform distribution from [0,1] where T=the number of epochs (max(t), the duration of operation 304 divided by granularity). For example, if duration of operation 304 is 10 hours with 30-minute granularity, then T=10/0.5=20, thus n=0.05, 0.1, . . . 1, and 3 hours in, yₜ=n₆*Y=0.3*Y, thus that the size of the changelog is at 30% of its final size.

In some embodiments, training logic 114 may train model 318 to assume a total size of the reserved area at system startup (e.g., t=0) based on initial inputs such as user type 302 and/or duration of operation 304. For example, at time zero y₀=β₀₀=T*Y, where T=the number of epochs and Y is the initially assumed size (determined as described above). Thus, at checkpointing initialization before receipt of file operation features, model 318 may output an assumption. Then, during operation (e.g., 0<t<T), as file operation features are received, the reserved area assumption may be validated and/or modified as needed. If the file operation features indicate that usage is lighter than expected, one or more of the remaining model parameters β may be negative, while if usage is heavier than the initial assumption, one or more of them may be positive.

Using the assumed changelog size Y and training portion of the received feature array F, training logic 114 may alter the model parameters β and evaluate error ϵ for varying t. Training logic 114 is generally configured to determine model parameters that minimize the error. Error may be minimized using any of a plurality of different methods (e.g., min-square minimization, ordinary least squares (OLS), generalized least squares (GLS), instrumental variables (IV) regression, etc.). In some embodiments, error minimization may generally be an iterative process; e.g., selecting model parameters β, evaluating and storing resulting error ϵ for each t, determining an overall error associated with a set of model parameters based on the individual errors, repeating the process for a different model parameter vector β, determining the lowest overall error, and selecting the corresponding model parameters.

Once the error of the training portion is minimized, training logic 114 is generally configured to validate accuracy of model 318 based on the validation portion(s) of the received feature array F. For example, file operation features from a validation set are input into model 318, and an output size of a reserved area is compared to a known size of a changelog. As running out of space in reserved area 206 is typically problematic for checkpointing, when validating model 318, training logic 114 is generally configured to favor overestimation of the required space for reserved area 206 more than underestimation. In some embodiments, this is achieved by model 318 outputting an upper bound of a 95% confidence interval of the predicted changelog. For example, if model 318 predicts that the size of the changelog is 95% likely to fall within the interval of [1.5 GB, 3 GB], the model 318 may use the 3 GB value as the output. In at least one example, if the known changelog size is 2.3 GB and the 95% confidence interval of the predicted value is [1.8, 2.1], then the model outputs 2.1 GB, which compared with the known changelog size of 2.3 GB is an underestimation, and the parameters (e.g., β) are modified. The exact nature of the parameter modification depends upon the error minimization method being used. As noted above, depending upon the type of model 308, training logic 114 may not consider the validation portion of the sample data during training to prevent overfitting of model 318.

In some embodiments, training logic 114 may divide the received sample data 300 into multiple time series windows (e.g., a first time series window may be from [0, 0.1T], or 10% of the total sample data). Within these windows, training logic 114 may use 40% of the time series data for training and 60% of the time series data for validation (e.g., [0, 0.04T] for training, (0.04T, 0.1T) for validation). This may advantageously enable training logic 114 to train model 318 over multiple diverse data sets and account for possible differences that develop over time. For example, were training logic 114 to simply use the first 40% of sample data 300 for training, then model 318 may be overfit to earlier usage. By breaking sample data 300 into multiple windows and then dividing those windows further, training logic 114 is able to maintain a 40%/60% (or other divide, e.g., 50%/50%, 30%/70%, etc.) split in training/validation data while still training (and validating) based on data from throughout the sample operation.

In some embodiments, training logic 114 may simply categorize the received sample data into training portion(s) (e.g., the first 60% of the time series of features) and validation portion(s) (e.g., the last 40% portion of the time series of features) in order to validate model 308 using any of a plurality of methods, for example cross-validation (e.g., 10-fold cross validation, “leave one out” cross validation, etc.), residual analysis, etc.

Training logic 114 may train multiple models, with each model associated with a user type (e.g., model 318-A “Gamer,” model 318-B “Internet Surfer,” etc. (not shown)). However, in some embodiments, training logic 114 may train a single model 318 including a user type parameter, e.g., parameter β₀₀. For example, in some embodiments, β₀₀=k*Y*T, wherein k is a dimensionless variable depending upon user type (e.g., for “Gamer,” k may be 2.5, “Internet Surfer” may have k=0.75, etc.). T is the number of epochs for the time series. For example, if the duration of operation is 7 days and the granularity is 1 day, then T=7/1=7. In other embodiments, output yₜ may simply be multiplied by k. In some embodiments, only one value (e.g., y₀₀) may be multiplied by k. Training logic 114 is generally configured to develop model 318 to determine a reserved area 206 as a function of time.

As usage, and therefore required changelog size, is likely to vary even by the same user on the same system, training logic 114 is further generally configured to develop and train model 318 to determine a range of possible sizes for a reserved area with corresponding confidence ratings. As an example, a typical “gamer” type user may require 1.3 GB per day of checkpoint duration. However, on any particular day, tracking an actual user may require more (or less) space, often in ways that are difficult or impossible to predict. For example, a gamer's system usage may be heavier on a friend's birthday. Thus, rather than attempt to determine an exact amount required per day, model 318 outputs a range of sizes based on likelihood. Using the same example, output of model 318 may indicate that the gamer user requires 1.3 GB per day with a 50% confidence rating, implying that model 318 predicts a 50% chance that the user requires up to 1.3 GB/day and a 50% chance that the user requires more than 1.3 GB/day. As underestimations are often fatal to checkpointing systems, training logic 114 may train model 318 to select an estimate with a high confidence rating (e.g., an estimate that model 318 predicts is 95% likely to be sufficient) for use for reserved area 206.

FIG. 4 illustrates inputs and outputs of runtime prediction logic 116 consistent with several embodiments of the present disclosure. Runtime prediction logic 116 is generally configured to receive input data 400 (including user type 402 and duration of operation 404), use model 318 to determine a reserved area prediction 430 (wherein a size of reserved area 206 is based on prediction 430), and to receive file operation features 420 (including operation type 406, block ID 408, file information 410 and visible size 412 of storage device 108) from OS 112. As an application is executed by processor 104, read and write requests will be sent to storage device 108 via interfaces 106 and 212. Depending upon the location of runtime prediction logic 116 (e.g., in host memory 110 or storage device memory 210), the corresponding interface will send information (e.g., file operation features 420) corresponding to the read and/or write requests to the runtime prediction logic 116. For example, the block ID 408 corresponds to the location in memory array 204 (e.g., LBA 208-1, etc.) where the data is being read from or written to. File information 410 may correspond to details about the file performing the read or write operation, including e.g., filename, storage location of the file, the size of the file, etc. Visible size 412 may be the free space in memory array 204 (e.g., in GB) at the time of the operation. In some embodiments, visible size 412 may be the total size of memory array 204.

When checkpointing is initialized (e.g., t=0), logic 116 may not have any file operation features 420 to use with model 318 for prediction. Instead, logic 116 may determine prediction 430 based solely on parameters included within model 318, e.g. y₀₀=β₀₀=k*Y*T, where k is a user type 402, Y is an initial assumption (determined as described above), and T is total number of epochs (based upon duration of operation 404 and granularity). In some embodiments, Y or y₀₀ may be input by a user.

During operation (e.g., as applications are executed by processor 104), runtime prediction logic 116 is further configured to use file operation features 420 to further validate model 318 and update parameters of model 318 if necessary. For example, runtime prediction logic may determine (via model 318) a new predicted area based on file operation features 420 and compare the new predicted area to reserved area prediction 430 to determine a prediction error. If runtime prediction logic 116 determines that the initial reserved area prediction 430 is smaller than the new predicted area, then runtime prediction logic 116 may adjust parameters of model 318 until model 318's output is greater than the new predicted area. Runtime prediction logic 116 may use similar error minimization methods as training logic 114 (e.g., ordinary least squares (OLS)), using file operation features 420 for validation.

In some embodiments, runtime prediction logic 116 is configured to determine, based on monitored usage (e.g., file operation features 420), user type 402. This may be advantageous if, for example, a user implements an incorrect user type 402, a different user is using the system, or if the user type 402 is not input at all (which may result in runtime prediction logic 116 assuming a default user type). For example, if collected file operation features 420 show that the changelog of storage system 100 is growing at a rate consistent with a “database scientist” but model 318 is operating with user type 402 of a “gamer,” reserved area prediction 430 may include error depending upon the difference between predictions based on these user types. Thus, when detecting an error between prediction 430 and a prediction based on features 420, runtime prediction logic 116 may determine new predictions based on model 318 with differing user types 402 before adjusting parameters of model 318. If one of the different user type predictions of model 318 is more accurate than prediction 430, then runtime prediction logic 116 may change the user type 402 to the value associated with the most accurate of the predictions. This may be advantageous if, for example, model parameters other than a user type parameter are accurate, so a simple change of k may resolve accuracy issues more quickly and reliably than adjusting multiple β values. However, adjusting the parameters of the model may generally enable model 318 to become more accurate to the specific user, so adjusting model parameters is generally preferable to repeatedly switching the model between multiple user types. Thus, in some embodiments, runtime prediction logic 116 may be configured to only switch user types if the accuracy improvement that would result from a switch is above a predetermined threshold (e.g., at least 20% improvement).

In some embodiments, runtime prediction logic 116 is additionally configured to modify the size of reserved area 206 based upon the monitored file operation features 420. In general, if logic 116 determines that the initial reserved area prediction 430 is likely to be insufficient or inaccurate (e.g., the changelog is growing at a rate such that it will exceed the size of reserved area 206 before the selected checkpointing timespan), logic 116 may modify the size of reserved area 206. As modification of the reserved area 206 may result in significant file system overhead, runtime prediction logic 116 may be configured to only modify size of reserved area 206 in response to determining that reserved area 206 is near-certain to be insufficient (e.g., new size estimates are above a threshold (e.g., 25%) greater than reserved area 206). In some embodiments, if reserved area 206 is likely to be insufficient in size, runtime prediction logic 116 may be configured to modify the size of reserved area 206 with an additional buffer. As an example, if initial area prediction 430 is 1 GB, and upon receiving file operation features 420 model 318 makes a new area prediction with 95% confidence interval of [0.9 GB, 1.5 GB], rather than simply select the upper bound 1.5 GB, runtime prediction logic 116 may add an additional buffer of 10%, e.g., modify size of reserved area 206 from 1 GB to 1.5 GB*1.10=1.65 GB. While this may result in wasted space, a significant underestimation of required size of reserved area 206 may indicate that model 318 is undertrained and thus that the new prediction may not be correct, either—therefore, adding in an additional buffer may advantageously help runtime prediction logic 116 avoid having to perform the costly operation of adjusting the size of reserved area 206 more than once.

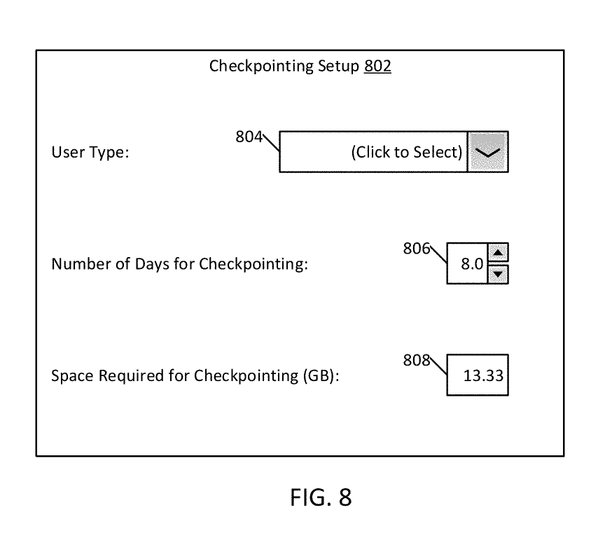

In some embodiments, runtime prediction logic 116 may provide a user interface. The user interface is described further in relation to FIG. 8, below, but in general, the user interface is configured to enable a user to select an initial user type 402 and checkpoint timespan 404. Runtime prediction logic 116 may additionally provide the user interface during operation to enable a user to change user type 402 and timespan 404.

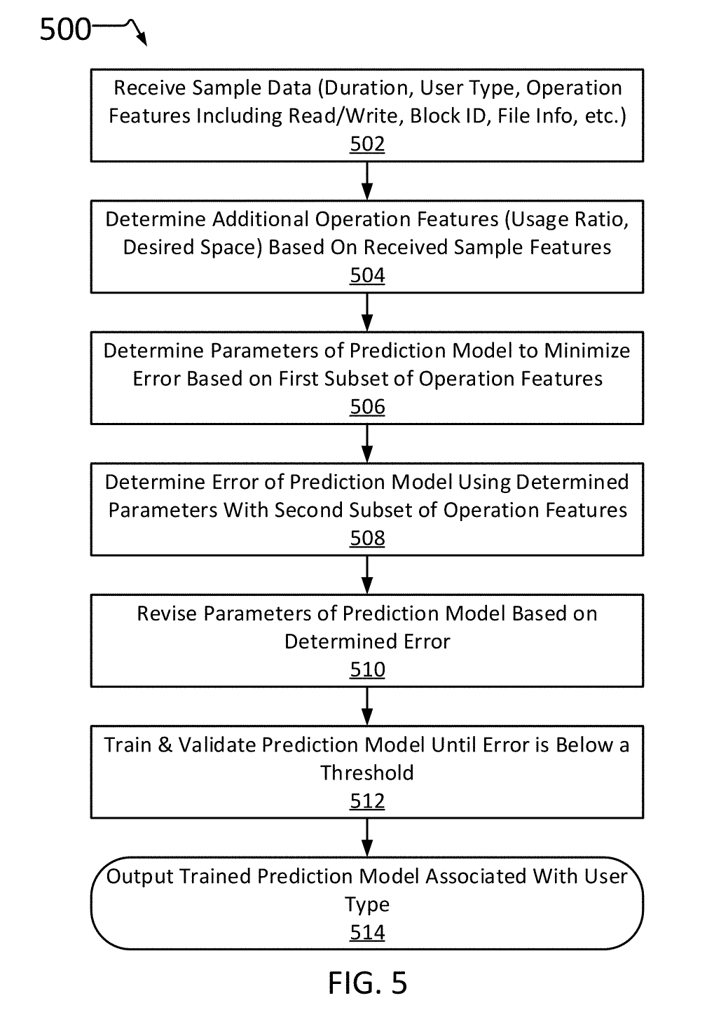

FIG. 5 is a flowchart 500 illustrating operations according to various embodiments of the present disclosure. In particular, flowchart 500 illustrates training a model (such as model 318) to predict a size of a reserved area for checkpointing. The operations of flowchart 500 may be performed by, for example, training logic 114. Operations of this embodiment may include receiving sample data 502, the sample data including, e.g., a duration of operation, a user type, and operation features including read/write operations, block ID of the operations, file information (including file name and location), etc. Operations of this embodiment may also include determining additional operation features 504. The additional operation features may include, for example, a usage ratio and desired space. The additional operation features may be determined based on the received sample operations. For example, the usage ratio may be determined as an amount of data (e.g., in kB) added or modified over a time period in the sample data divided by the total available space in the storage device at the beginning of the time period.

Operations of this embodiment may further include determining parameters of a prediction model to minimize error based on a first subset of the sample and additional operation features 506. Operations of this embodiment may additionally include determining an error of the prediction model when using the determined parameters with a second subset of the operation features 508. This may include validating the model. Operations of this embodiment may also include revising the parameters of the prediction model based on the determined error 510. Operations may additionally include repeatedly training and validating the prediction model as necessary until the determined error falls below a threshold 512. The training and validating may include any of a plurality of methods as described above (e.g., 10-fold cross validation, OLS, etc.). Operations of this embodiment may also include outputting the trained prediction model 514, wherein the outputted model is associated with the user type of the sample data. The model may be output to, for example, runtime prediction logic. In some embodiments, the model may include a parameter corresponding to the user type. In the same or other embodiments, the user type may be appended (e.g., as a tag) to the data packet(s) in which the model itself is output.

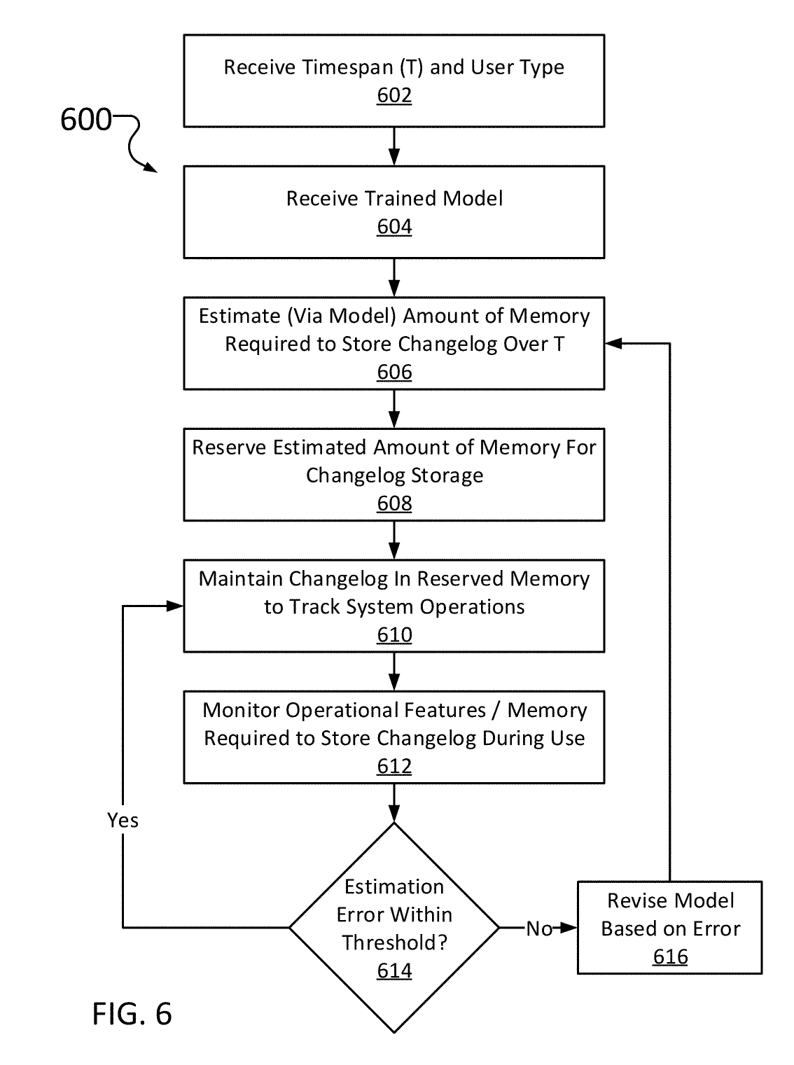

FIG. 6 is a flowchart 600 illustrating operations according to various embodiments of the present disclosure. In particular, flowchart 600 illustrates predicting a size of a reserved area for checkpointing using a trained model, as well as monitoring operational features to continuously validate the model. Operations of this embodiment may be performed by, for example, runtime prediction logic 116. Operations of this embodiment may include receiving a timespan (T) and a user type 602. The user type may correspond to user type 402 while the timespan may correspond to duration of checkpoint operation 404. The timespan and user type may be received via user input, or may be set to default values. Operations of this embodiment may also include receiving a trained model 604. The model may be received from training logic, e.g., training logic 114. In some embodiments, a trained model may be pre-installed in the runtime prediction logic. Operations of this embodiment may further include estimating, via the model, an amount of memory required to store a changelog over the timespan 606. For example, this may include determining a size of a reserved area (e.g., reserved area 206) in order to store a changelog to enable checkpointing of a system (e.g., system 100). Operations of this embodiment may additionally include reserving the estimated amount of memory for changelog storage 608. This may include causing a processor to send instructions to a storage device to reserve an area in a memory array. In some embodiments, operation 608 may include sending the instructions to the storage device directly.

Operations of this embodiment may also include maintaining a changelog in the reserved area of memory to track operations of a device or system 610. For example, as read/write operations are performed or executed by a processor, data representing these operations may be logged or recorded in the reserved area. Operations of this embodiment may further include monitoring memory required to store the changelog during operation of the system or device 612. The memory required to store the changelog may be monitored via, for example, receiving operational features corresponding to the read and/or write operations performed during operation of the system or device. Operations of this embodiment may also include determining whether an estimation error is within a threshold 614. For example, based on the operational features, a new prediction of a required size of a reserved area may be made using the model. 614 may include comparing such a new prediction to the original estimate to determine an error. If the error is within a preset threshold (e.g., 614 “Yes”), operations of this embodiment may further include continuing to track operations by maintaining the changelog 610. If the error is outside the preset threshold (e.g., 614 “No”), operations of this embodiment may further include revising the model based upon the error and the monitored features 616, and determining a new estimate via the revised model of the amount of memory required 606.

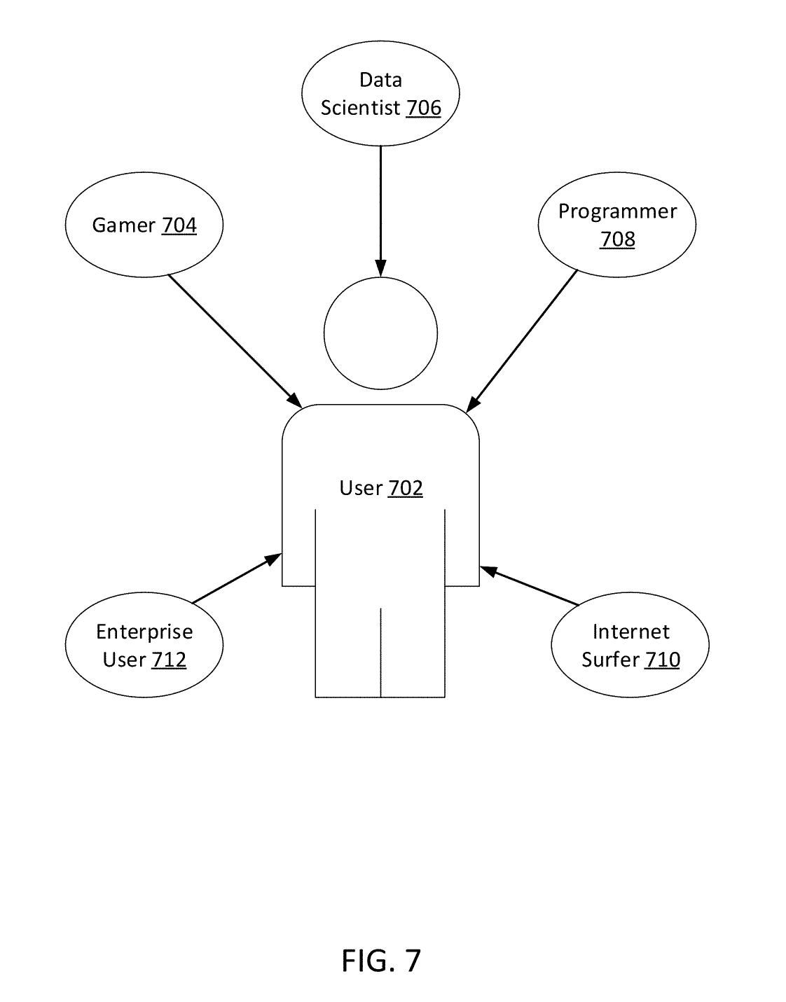

FIG. 7 illustrates several possible user types of a user 702 according to several embodiments of the present disclosure. A user 702 may be classified as, for example, a gamer 704, aa data scientist 706, a programmer 708, an internet surfer 710 or an enterprise user 712. As described above, knowing the user type of user 702 may assist a model in determining a more accurate size of a reserved area to store a changelog of operations performed during use of a system. The user types shown in FIG. 7 are merely examples; other user types may be used.

FIG. 8 Illustrates an example user interface 802 to enable a user to set up checkpointing and input parameters. Interface 802 enables a user to select a user type 804 (e.g., to be input to runtime prediction logic 116 as user type 402) and a number of days for checkpointing 806 (e.g., to be input to runtime prediction logic 116 as duration of operation 404). Interface 802 may further provide an estimated amount of space required for checkpointing 808 (e.g., reserved area prediction 430 output from runtime prediction logic 116). Interface 802 may be provided to a user upon startup or system initialization (e.g., prior to launch of OS 112), or may be initiated by a user during regular use of the system (e.g., at runtime). Note that while the “User Type” menu 804 is depicted as a dropdown menu initially stating “Click to Select,” in some embodiments the interface is accessible via, e.g., basic input/output system (BIOS) or other interfaces wherein mouse controls may not be available. In this and other embodiments, interface 802 may have a different appearance (e.g., to better enable keyboard-only selection).

As used in any embodiment herein, the term “logic” may refer to an application, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip, such as an application-specific integrated circuit (ASIC), etc. In some embodiments, the circuitry may be formed, at least in part, by a processor (e.g., processor 104) executing code and/or instructions sets (e.g., software, firmware, etc.) corresponding to the functionality described herein, thus transforming a general-purpose processor into a specific-purpose processing environment to perform one or more of the operations described herein. In some embodiments, the various components and circuitry of the memory controller circuitry or other systems may be combined in a system-on-a-chip (SoC) architecture.

The foregoing provides example system architectures and methodologies, however, modifications to the present disclosure are possible. For example, the processor may include one or more processor cores and may be configured to execute system software. System software may include, for example, an operating system. Device memory may include I/O memory buffers configured to store one or more data packets that are to be transmitted by, or received by, a network interface.

The operating system (OS) 112 may be configured to manage system resources and control tasks that are run on, e.g., system 100. For example, the OS may be implemented using Microsoft® Windows®, HP-UX®, Linux®, or UNIX®, although other operating systems may be used. In another example, the OS may be implemented using Android™, iOS, Windows Phone® or BlackBerry®. In some embodiments, the OS may be replaced by a virtual machine monitor (or hypervisor) which may provide a layer of abstraction for underlying hardware to various operating systems (virtual machines) running on one or more processing units. The operating system and/or virtual machine may implement a protocol stack. A protocol stack may execute one or more programs to process packets. An example of a protocol stack is a TCP/IP (Transport Control Protocol/Internet Protocol) protocol stack comprising one or more programs for handling (e.g., processing or generating) packets to transmit and/or receive over a network.

Host memory 110 and storage device memory 210 may each include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

In some embodiments, a Verilog hardware description language (HDL) may be used to specify circuit and/or logic implementation(s) for the various logic and/or circuitry described herein. For example, in one embodiment, the HDL may comply or be compatible with IEEE standard 62530-2011: SystemVerilog-Unified Hardware Design, Specification, and Verification Language, dated Jul. 07, 2011; IEEE Std 1800™-2012: IEEE Standard for SystemVerilog-Unified Hardware Design, Specification, and Verification Language, released Feb. 21, 2013; IEEE standard 1364-2005: IEEE Standard for Verilog Hardware Description Language, dated Apr. 18, 2006 and/or other versions of Verilog HDL and/or SystemVerilog standards.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

The following examples pertain to further embodiments. The following examples of the present disclosure may comprise subject material such as an apparatus, a method, at least one machine-readable medium for storing instructions that when executed cause a machine to perform acts based on the method, means for performing acts based on the method and/or a system for checkpoint changelog reserved area prediction model training.

According to example 1, there is provided an apparatus capable of estimating a reserved area. The apparatus may comprise a storage device and training logic to receive sample data, the sample data including a sample user type and a plurality of sample file operation features, train a prediction model based on a first subset of the sample file operation features, validate the prediction model based on a second subset of the sample file operation features, and send the prediction model to runtime prediction logic, wherein the runtime prediction logic is to receive the prediction model from the training logic, receive at least a user type and a duration, estimate, via the prediction model, a first changelog size based at least on the user type and the duration, and reserve an area of the storage device, the reserved area having a size corresponding to the estimated first changelog size.

Example 2 may include the elements of example 1, wherein the training logic to train a prediction model based on a first subset of the sample file operation features and validate the prediction model based on a second subset of the sample file operation features comprises training logic to determine parameters of a prediction model to minimize an error of the prediction model based on a first subset of the plurality of sample file operation features, determine a validation error of the prediction model based on the determined parameters and a second subset of the plurality of sample file operation features, revise the determined parameters of the prediction model based at least on the validation error, and train and validate the prediction model until the validation error is below a threshold.

Example 3 may include the elements of example 1, further comprising a processor to execute at least an operating system (OS), wherein, during execution of the OS, the runtime prediction logic is further to determine at least one change made to data stored on the storage device, and store data corresponding to the at least one change in a changelog in the reserved area of the storage device.

Example 4 may include the elements of example 3, wherein the runtime prediction logic is further to receive file operation features from the OS corresponding to file operations performed during execution of the OS, estimate, via the prediction model, a second changelog size based at least on the received file operation features, and determine a runtime error of the prediction model based on a comparison between the estimated first changelog size and the estimated second changelog size.

Example 5 may include the elements of example 4, wherein, responsive to a determination that the runtime error of the prediction model is above a threshold, the runtime prediction logic is further to revise the parameters of the prediction model based at least on the runtime error and the received file operation features, and estimate, via the prediction model, a third changelog size based on the revised parameters and the received file operation features.

Example 6 may include the elements of example 5, wherein, responsive to the determination that the runtime error of the prediction model is above the threshold, the runtime prediction logic is further to modify the size of the reserved area based on the estimated third changelog size.

Example 7 may include the elements of any of examples 1 to 6, wherein the reserved area is to enable checkpointing of the system.

Example 8 may include the elements of any of examples 1 to 6, wherein the prediction model is a linear regression model.

Example 9 may include the elements of any of examples 1 to 6, wherein the training logic is to validate the prediction model based at least on the second subset of the file operation features using 10-fold cross validation.

Example 10 may include the elements of any of examples 1 to 6, wherein the sample file operation features include a plurality of window sets, the first subset of the sample file operation features includes a first window subset of each window set, and the second subset of the sample file operation features includes a second window subset of each window set.

Example 11 may include the elements of any of examples 1 to 6, wherein the training logic is further to determine at least one sample additional feature based on the sample file operation features, the training logic is to train the prediction model based on a first subset of the sample file operation features and a first additional subset of the at least one sample additional feature, and the training logic is to validate the prediction model based on a second subset of the sample file operation features a second additional subset of the at least one sample additional feature.

Example 12 may include the elements of example 11, wherein the at least one sample additional feature includes a usage ratio.

Example 13 may include the elements of example 11, wherein the at least one sample additional feature includes a desired space.

Example 14 may include the elements of any of examples 1 to 6, wherein the sample file operation features include features selected from a group consisting of an operation identifier, a block identifier, file information, and a visible size of a sample storage device.

Example 15 may include the elements of any of examples 4 to 6, wherein the received file operation features include features selected from a group consisting of an operation identifier, a block identifier, file information, and a visible size of a disk.

Example 16 may include the elements of any of examples 1 to 6, wherein the user type is selected from a group consisting of a gamer, a data scientist, a programmer, an internet surfer, and an enterprise user.

Example 17 may include the elements of any of examples 3 to 6 wherein the runtime prediction logic to, during execution of the OS, store data corresponding to the at least one change in a changelog in the reserved area of the storage device comprises runtime prediction logic is to, during execution of the OS, determine whether the at least one change is an omittable change, and responsive to a determination that the at least one change is not an omittable change, store data corresponding to the at least one change in a changelog in the reserved area of the storage device.

Example 18 may include the elements of example 17, wherein the runtime prediction logic to, during execution of the OS, determine whether the at least one change is an omittable change comprises runtime prediction logic to, during execution of the OS, determine whether the at least one change includes a change associated with a temporary file, or a change associated with a frequent operation file, wherein the frequent operation file is associated with changes at a frequency above a threshold.

According to example 19, there is provided a method for configuring a storage device. The method may comprise receiving, at training logic, sample data, the sample data including at least a sample user type and a plurality of sample file operation features, training, via the training logic, a prediction model based on a first subset of the sample file operation features, validating, via the training logic, the prediction model based on a second subset of the sample file operation features, sending, via interface circuitry, the prediction model to runtime prediction logic, receiving, at runtime prediction logic, the training model, receiving, at the runtime prediction logic, a user type and duration, estimating, by the runtime prediction logic via the prediction model, a first changelog size based at least on the user type, and reserving, via the runtime prediction logic, an area of the storage device, the reserved area having a size corresponding to the estimated first changelog size.

Example 20 may include the elements of example 19, wherein the training, via the training logic, a prediction model based on a first subset of the sample file operation features and validating, via the training logic, the prediction model based on a second subset of the sample file operation features comprises determining, via the training logic, parameters of a prediction model to minimize an error of the prediction model based on a first subset of the plurality of sample file operation features, determining, via the training logic, a validation error of the prediction model based on the determined parameters and a second subset of the plurality of sample file operation features, revising, via the training logic, the determined parameters of the prediction model based at least on the validation error, and training and validating, via the training logic, the prediction model until the validation error is below a threshold.

Example 21 may include the elements of example 19, further comprising executing, via a processor, an operating system (OS), determining, via the runtime prediction logic during execution of the OS, at least one change made to data stored on the storage device, and storing, via the runtime prediction logic during execution of the OS, data corresponding to the at least one change in a changelog in the reserved area of the storage device.

Example 22 may include the elements of example 21, further comprising receiving, at the runtime prediction logic, file operation features from the OS corresponding to file operations performed during execution of the OS, estimating, by the runtime prediction logic via the prediction model, a second changelog size based at least on the received file operation features, and determining, via the runtime prediction logic, a runtime error of the prediction model based on a comparison between the estimated first changelog size and the estimated second changelog size.

Example 23 may include the elements of example 22, further comprising, responsive to a determination that the runtime error of the prediction model is above a threshold, revising, via the runtime prediction logic, the parameters of the prediction model based at least on the runtime error and the received file operation features, and estimating, by the runtime prediction logic via the prediction model, a third changelog size based on the revised parameters and the received file operation features.

Example 24 may include the elements of example 23, further comprising, responsive to the determination that the runtime error of the prediction model is above a threshold, modifying, via the runtime prediction logic, the size of the reserved area based on the estimated third changelog size.

Example 25 may include the elements of any of examples 19 to 24, wherein the reserved area is to enable checkpointing of the system.

Example 26 may include the elements of any of examples 19 to 24, wherein the prediction model is a linear regression model.

Example 27 may include the elements of any of examples 19 to 24, wherein the validating, via the training logic, the prediction model based on a second subset of the sample file operation features comprises validating, via the training logic, the prediction model based on a second subset of the sample file operation features using 10-fold cross validation.

Example 28 may include the elements of any of examples 19 to 24, wherein the sample file operation features include a plurality of window sets, the first subset of the sample file operation features includes a first window subset of each window set, and the second subset of the sample file operation features includes a second window subset of each window set.

Example 29 may include the elements of any of examples 19 to 24, further comprising determining, via the training logic, at least one sample additional feature based on the sample file operation features, wherein the training, via the training logic, a prediction model based on a first subset of the sample file operation features comprises training, via the training logic, a prediction model based on a first subset of the sample file operation features and a first additional subset of the at least one sample additional feature, and the validating, via the training logic, the prediction model based on a second subset of the sample file operation features comprises validating, via the training logic, the prediction model based on a second subset of the sample file operation features and a second additional subset of the at least one sample additional feature.

Example 30 may include the elements of example 29, wherein the at least one sample additional feature includes a usage ratio.

Example 31 may include the elements of example 29, wherein the at least one sample additional feature includes a desired space.

Example 32 may include the elements of any of examples 19 to 24, wherein the sample file operation features include features selected from a group consisting of an operation identifier, a block identifier, file information, and a visible size of a sample storage device.

Example 33 may include the elements of any of examples 22 to 24, wherein the received file operation features include features selected from a group consisting of an operation identifier, a block identifier, file information, and a visible size of the storage device.

Example 34 may include the elements of any of examples 19 to 24, wherein the user type is selected from a group consisting of a gamer, a data scientist, a programmer, an internet surfer, and an enterprise user.

Example 35 may include the elements of any of examples 21 to 24, wherein the storing, via the runtime prediction logic during execution of the OS, data corresponding to the at least one change in a changelog in the reserved area of the storage device comprises determining, via the runtime prediction logic, whether the at least one change is an omittable change, and responsive to a determination that the at least one change is not an omittable change, storing, via the runtime prediction logic, data corresponding to the at least one change in a changelog in the reserved area of the storage device.

Example 36 may include the elements of example 35, wherein the determining, via the runtime prediction logic, whether the at least one change is an omittable change comprises determining, via the runtime prediction logic, whether the at least one change includes a change associated with a temporary file or a change associated with a frequent operation file, wherein the frequent operation file is associated with changes at a frequency above a threshold.

According to example 37 there is provided a system including at least one device, the system being arranged to perform the method of any of the above examples 19 to 36.

According to example 38 there is provided a chipset arranged to perform the method of any of the above examples 19 to 36.

According to example 39 there is provided at least one non-transitory computer readable storage device having stored thereon instructions that, when executed on a computing device, cause the computing device to carry out the method according to any of the above examples 19 to 36.

According to example 40 there is provided at least one apparatus configured for changelog reserved area prediction, the at least one apparatus being arranged to perform the method of any of the above examples 19 to 36.

According to example 41 there is provided a system for configuring a storage device. The system may comprise means for receiving sample data, the sample data including at least a sample user type and a plurality of sample file operation features, means for training a prediction model based on a first subset of the sample file operation features, means for validating the prediction model based on a second subset of the sample file operation features, means for sending the prediction model to runtime prediction logic, means for receiving the training model, means for receiving a user type and duration, means for estimating a first changelog size based at least on the user type, and means for reserving an area of the storage device, the reserved area having a size corresponding to the estimated first changelog size.

Example 42 may include the elements of example 41, wherein the means for training a prediction model based on a first subset of the sample file operation features comprises means for determining parameters of a prediction model to minimize an error of the prediction model based on a first subset of the plurality of sample file operation features, and the means for validating the prediction model based on a second subset of the sample file operation features comprises means for determining a validation error of the prediction model based on the determined parameters and a second subset of the plurality of sample file operation features, means for revising the determined parameters of the prediction model based at least on the validation error, and means for training and validating the prediction model until the validation error is below a threshold.

Example 43 may include the elements of example 41, further comprising means for executing an operating system (OS), means for determining, during execution of the OS, at least one change made to data stored on the storage device, and means for storing, during execution of the OS, data corresponding to the at least one change in a changelog in the reserved area of the storage device.

Example 44 may include the elements of example 43, further comprising means for receiving file operation features from the OS corresponding to file operations performed during execution of the OS, means for estimating a second changelog size based at least on the received file operation features, and means for determining a runtime error of the prediction model based on a comparison between the estimated first changelog size and the estimated second changelog size.

Example 45 may include the elements of example 44, further comprising means for revising, responsive to a determination that the runtime error of the prediction model is above a threshold, the parameters of the prediction model based at least on the runtime error and the received file operation features, and means for estimating, responsive to a determination that the runtime error of the prediction model is above a threshold, a third changelog size based on the revised parameters and the received file operation features.

Example 46 may include the elements of example 45, further comprising means for modifying, responsive to the determination that the runtime error of the prediction model is above a threshold, the size of the reserved area based on the estimated third changelog size.

Example 47 may include the elements of any of examples 41 to 46, wherein the reserved area is to enable checkpointing of the system.

Example 48 may include the elements of any of examples 41 to 46, wherein the prediction model is a linear regression model.

Example 49 may include the elements of any of examples 41 to 46, wherein the means for validating the prediction model based on a second subset of the sample file operation features comprises means for validating the prediction model based on a second subset of the sample file operation features using 10-fold cross validation.

Example 50 may include the elements of any of examples 41 to 46, wherein the sample file operation features include a plurality of window sets, the first subset of the sample file operation features includes a first window subset of each window set and the second subset of the sample file operation features includes a second window subset of each window set.

Example 51 may include the elements of any of examples 41 to 46, further comprising means for determining at least one sample additional feature based on the sample file operation features, wherein the means for training a prediction model based on a first subset of the sample file operation features comprises means for training a prediction model based on a first subset of the sample file operation features and a first additional subset of the at least one sample additional feature, and the means for validating the prediction model based on a second subset of the sample file operation features comprises means for validating the prediction model based on a second subset of the sample file operation features and a second additional subset of the at least one sample additional feature.

Example 52 may include the elements of example 51, wherein the at least one sample additional feature includes a usage ratio.

Example 53 may include the elements of example 51, wherein the at least one sample additional feature includes a desired space.

Example 54 may include the elements of any of examples 41 to 46, wherein the sample file operation features include features selected from a group consisting of an operation identifier, a block identifier, file information, and a visible size of a sample storage device.

Example 55 may include the elements of any of examples 44 to 46, wherein the received file operation features include features selected from a group consisting of an operation identifier, a block identifier, file information, and a visible size of the storage device.

Example 56 may include the elements of any of examples 41 to 46, wherein the user type is selected from a group consisting of a gamer, a data scientist, a programmer, an internet surfer, and an enterprise user.

Example 57 may include the elements of any of examples 43 to 46, wherein the means for storing, during execution of the OS, data corresponding to the at least one change in a changelog in the reserved area of the storage device comprises means for determining whether the at least one change is an omittable change, and means for storing, responsive to a determination that the at least one change is not an omittable change, data corresponding to the at least one change in a changelog in the reserved area of the storage device.

Example 58 may include the elements of example 57, wherein the means for determining whether the at least one change is an omittable change comprises means for determining whether the at least one change includes a change associated with a temporary file or a change associated with a frequent operation file, wherein the frequent operation file is associated with changes at a frequency above a threshold.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A device, comprising:
a storage device; and
training logic to:
receive sample data, the sample data including:
a sample user type; and
a plurality of sample file operation features;
train a prediction model based on a first subset of the sample file operation features;
validate the prediction model based on a second subset of the sample file operation features; and
send the prediction model to runtime prediction logic;
wherein the runtime prediction logic is to:
receive the prediction model from the training logic;
receive at least a user type and a duration;
estimate, via the prediction model, a first changelog size based at least on the user type and the duration; and
reserve an area of the storage device, the reserved area having a size corresponding to the estimated first changelog size.

2. The device of claim 1, wherein the training logic to train a prediction model based on a first subset of the sample file operation features and validate the prediction model based on a second subset of the sample file operation features comprises training logic to:
determine parameters of a prediction model to minimize an error of the prediction model based on a first subset of the plurality of sample file operation features;
determine a validation error of the prediction model based on the determined parameters and a second subset of the plurality of sample file operation features;
revise the determined parameters of the prediction model based at least on the validation error; and
train and validate the prediction model until the validation error is below a threshold.

3. The device of claim 1, further comprising a processor to execute at least an operating system (OS), wherein, during execution of the OS, the runtime prediction logic is further to:
determine at least one change made to data stored on the storage device; and
store data corresponding to the at least one change in a changelog in the reserved area of the storage device.

4. The device of claim 3, wherein the runtime prediction logic is further to:
receive file operation features from the OS corresponding to file operations performed during execution of the OS;
estimate, via the prediction model, a second changelog size based at least on the received file operation features; and
determine a runtime error of the prediction model based on a comparison between the estimated first changelog size and the estimated second changelog size.

5. The device of claim 4, wherein, responsive to a determination that the runtime error of the prediction model is above a threshold, the runtime prediction logic is further to:
revise the parameters of the prediction model based at least on the runtime error and the received file operation features; and
estimate, via the prediction model, a third changelog size based on the revised parameters and the received file operation features.

6. The device of claim 5, wherein, responsive to the determination that the runtime error of the prediction model is above the threshold, the runtime prediction logic is further to modify the size of the reserved area based on the estimated third changelog size.

7. The device of claim 1, wherein the reserved area is to enable checkpointing of the system.

8. The device of claim 1, wherein the prediction model is a linear regression model.

9. The device of claim 1, wherein the training logic is to validate the prediction model based at least on the second subset of the file operation features using 10-fold cross validation.

10. A method for configuring a storage device, comprising:
receiving, at training logic, sample data, the sample data including at least:
a sample user type; and
a plurality of sample file operation features;
training, via the training logic, a prediction model based on a first subset of the sample file operation features;
validating, via the training logic, the prediction model based on a second subset of the sample file operation features;
sending, via interface circuitry, the prediction model to runtime prediction logic;
receiving, at runtime prediction logic, the training model;
receiving, at the runtime prediction logic, a user type and duration;
estimating, by the runtime prediction logic via the prediction model, a first changelog size based at least on the user type; and
reserving, via the runtime prediction logic, an area of a storage device, the reserved area having a size corresponding to the estimated first changelog size.

11. The method of claim 10, wherein the training, via the training logic, a prediction model based on a first subset of the sample file operation features and validating, via the training logic, the prediction model based on a second subset of the sample file operation features comprises:
determining, via the training logic, parameters of a prediction model to minimize an error of the prediction model based on a first subset of the plurality of sample file operation features;
determining, via the training logic, a validation error of the prediction model based on the determined parameters and a second subset of the plurality of sample file operation features;
revising, via the training logic, the determined parameters of the prediction model based at least on the validation error; and
training and validating, via the training logic, the prediction model until the validation error is below a threshold.

12. The method of claim 10, further comprising:
executing, via a processor, an operating system (OS);
determining, via the runtime prediction logic during execution of the OS, at least one change made to data stored on the storage device; and
storing, via the runtime prediction logic during execution of the OS, data corresponding to the at least one change in a changelog in the reserved area of the storage device.

13. The method of claim 12, further comprising:
receiving, at the runtime prediction logic, file operation features from the OS corresponding to file operations performed during execution of the OS;
estimating, by the runtime prediction logic via the prediction model, a second changelog size based at least on the received file operation features; and
determining, via the runtime prediction logic, a runtime error of the prediction model based on a comparison between the estimated first changelog size and the estimated second changelog size.

14. The method of claim 13, further comprising, responsive to a determination that the runtime error of the prediction model is above a threshold:
revising, via the runtime prediction logic, the parameters of the prediction model based at least on the runtime error and the received file operation features; and
estimating, by the runtime prediction logic via the prediction model, a third changelog size based on the revised parameters and the received file operation features.

15. The method of claim 14, further comprising, responsive to the determination that the runtime error of the prediction model is above a threshold, modifying, via the runtime prediction logic, the size of the reserved area based on the estimated third changelog size.

16. The method of claim 10, wherein the reserved area is to enable checkpointing of the system.

17. The method of claim 10, wherein the prediction model is a linear regression model.

18. The method of claim 10, wherein the validating, via the training logic, the prediction model based on a second subset of the sample file operation features comprises validating, via the training logic, the prediction model based on a second subset of the sample file operation features using 10-fold cross validation.

19. A computer readable storage device having stored thereon instructions that when executed by one or more processors result in the following operations comprising:
receive, at training logic, sample data, the sample data including:
a sample user type; and
a plurality of file operation features;
train, via the training logic, a prediction model based on a first subset of the file operation features;
validate, via the training logic, the prediction model based on a second subset of the file operation features;
send, via the training logic, the prediction model to runtime prediction logic;
receive, at the runtime prediction logic, the prediction model;
receive, at the runtime prediction logic, at least a user type and a duration;
estimate, by the runtime prediction logic via the prediction model, a first changelog size based at least on the user type; and
reserve, via the runtime prediction logic, an area of the storage device, the reserved area having a size corresponding to the estimated first changelog size.

20. The computer-readable storage device of claim 19, wherein the instructions resulting in the operations train, via the training logic, a prediction model based on a first subset of the file operation features and validate, via the training logic, the prediction model based on a second subset of the file operation features, when executed by the processor, result in additional operations comprising:
determine, via the training logic, parameters of a prediction model to minimize an error of the prediction model based on a first subset of the plurality of sample file operation features;
determine, via the training logic, a validation error of the prediction model based on the determined parameters and a second subset of the plurality of sample file operation features;
revise, via the training logic, the determined parameters of the prediction model based at least on the validation error; and
train and validate, via the training logic, the prediction model until the validation error is below a threshold.

21. The computer-readable storage device of claim 19, wherein the instructions, when executed by the one or more processors, result in additional operations comprising:
determine, via the runtime prediction logic during execution of an operating system (OS), at least one change made to data stored on the storage device; and
store, via the runtime prediction logic during execution of the OS, data corresponding to the at least one change in a changelog in the reserved area of the storage device.

22. The computer-readable storage device of claim 21, wherein the instructions, when executed by the one or more processors, result in additional operations comprising:
receive, via the runtime prediction logic, file operation features from the OS corresponding to file operations performed during execution of the OS;
estimate, by the runtime prediction logic via the prediction model, a second changelog size based at least on the received file operation features; and
determine, via the runtime prediction logic, a runtime error of the prediction model based on a comparison between the estimated first changelog size and the estimated second changelog size.

23. The computer-readable storage device of claim 22, wherein the instructions, when executed by the one or more processors, result in additional operations comprising:
responsive to a determination that the runtime error of the prediction model is above a threshold:
revise, via the runtime prediction logic, the parameters of the prediction model based at least on the runtime error and the received file operation features; and
estimate, by the runtime prediction logic via the prediction model, a third changelog size based on the revised parameters and the received file operation features.

24. The computer-readable storage device of claim 23, wherein the instructions, when executed by the one or more processors, result in additional operations comprising:
responsive to a determination that the runtime error of the prediction model is above a threshold, modify, via the runtime prediction logic, the size of the reserved area based on the estimated third changelog size.

25. The computer-readable storage device of claim 19, wherein the instructions which when executed by the one or more processors result in the operations estimate, by the runtime prediction logic via the prediction model, a first changelog size based at least on the user type, when executed by the one or more processors, result in additional operations comprising:
determine a plurality of estimates of the prediction model based at least on the user type and the duration, each of the plurality of estimates having a confidence rating; and
select an estimate from the plurality of estimates, the selected estimate having a confidence rating of at least 95%.
